(19) United States
(12) Patent Application Publication
(10) Pub. No.: US 2008/0084996 A1
(43) Pub. Date: Apr. 10, 2008

(54) Authenticated encryption method and apparatus

(75) Inventors: Liqun Chen, Bristol (GB); Jonathan Peter Buckingham, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/827,907

(22) Filed: Jul. 13, 2007

(30) Foreign Application Priority Data
Oct. 5, 2006 (GB) 0619682.8

(51) Int. Cl. H04L 9/28

(52) U.S. Cl. 380/28

(57) ABSTRACT

An authenticated encryption method and apparatus are described in which plaintext data is encrypted, using a secret key, to form ciphertext data. A message authentication code, MAC, is also formed in dependence on a combination of the ciphertext data and data characteristic of the plaintext data. The ciphertext data and the MAC are then output, for example, for storage to a storage medium. In a preferred embodiment a block cipher operating in GCM mode is adapted to cause the stored message authentication code to be dependent on the plaintext data.

### FIELD OF THE INVENTION

The present invention relates to an authenticated encryption method and apparatus; in particular, but not exclusively, the present invention relates to secure data storage using a block cipher operating in the Galois/Counter Mode.

### BACKGROUND OF THE INVENTION

In cryptography, a block cipher is a symmetric key cipher which operates on fixed-length groups of bits, termed blocks. When encrypting, a block cipher might take (for example) a 128-bit block of plaintext as input, and output a corresponding 128-bit block of ciphertext. The exact transformation between input and output is dependent on a secret key. Decryption is similar with each block of ciphertext block being converted to a block of plaintext in dependence on the secret key.

Of course, in many cases the data to be encrypted exceeds the block size, and various ways or “modes of operation” have been devised for using the basic block cipher to handling messages larger amounts of data. The simplest of these modes is the electronic codebook (ECB) mode, in which the message is split into blocks and each is encrypted separately. However, this mode suffers from the disadvantage that identical plaintext blocks are encrypted to identical ciphertext blocks. More complex modes of operation are therefore preferred and these modes generally require an “initialization vector” (often abbreviated to ‘IV’) which is a sort of dummy block to kick off the process for the first real block of data, and also to provide some randomization for the process. For most of these modes there is no need for the IV to be secret, but it is important that it is never reused with the same key.

One important mode of operation is the ‘counter mode’ as it effectively turns the block cipher into a stream cipher. A block cipher operating in the counter mode generates the next keystream block by encrypting successive values of a “counter”. The counter can be any simple function which produces a sequence which is guaranteed not to repeat with the same key and the same IV, although an actual counter is the simplest and most popular. A recent development of the counter mode is the “Galois/Counter Mode” or “GCM” mode which combines the counter mode of encryption with the Galois mode of authentication. Galois authentication uses Galois field multiplication which has the desirable property that it can be easily computed in parallel thus permitting higher throughput than authentication algorithms that use chaining modes.

A specification of the GCM mode can be found in the US National Institute of Standards and Technology (NIST) Special Publication 800-38D DRAFT (April, 2006): “Recommendation for Block Cipher Modes of Operation: Galois/Counter Mode (GCM) for Confidentiality and Authentication” Morris Dworkin, which is herein incorporated by reference. According to this Recommendation, it “specifies an authenticated encryption algorithm called Galois/Counter Mode (GCM) constructed from an approved symmetric key block cipher with a block size of 128 bits, such as the Advanced Encryption Standard (AES) algorithm that is specified in Federal Information Processing Standard (FIPS) Pub. 197. GCM provides assurance of confidentiality of data using a variation of the Counter mode of operation for encryption. GCM provides assurance of authenticity of the confidential data using a universal hash function that is defined over a binary Galois (i.e., finite) field. GCM can also provide authentication assurance for additional data that is not encrypted. This assurance is stronger than that provided by a (non-cryptographic) checksum or error detecting code.”

The assurance of authenticity is provided by forming a ‘message authentication code’, MAC, (referred to as a “TAG” in the NIST Recommendation) over a concatenation of the ciphertext and the additional non-encrypted data it is desired to authenticate. The TAG value protects both the integrity and authenticity of the concatenated data by allowing verifiers (who also possess the secret key) to detect any changes to the data (it being appreciated that both the TAG value and the additional non-encrypted data are sent/stored along with the ciphertext).

Because of the high throughput possible with the GCM mode, it is well suited for use in secure storage applications as well as for secure data transmission applications. Thus, the use of a block cipher operating in the GCM mode forms the basis for the recent IEEE draft secure data storage standard P1619.1/D9 “Draft Standard Architecture for Encrypted Variable Block Storage Media”; IEEE, July 2006.

Although the GCM mode provides both for the confidentiality of data and an assurance of authenticity, because the underlying cipher is a symmetric key cipher, when used in two-party applications such as secure data exchange, the desirable property of non-repudiation is not present (in such applications “non-repudiation” means that the party encrypting a message cannot deny that they did so—with a symmetric key cipher, one party can always claim that the other party was responsible). Prima facie, this is not an issue with applications such as secure data storage where the same party performs both data encryption and decryption.

### SUMMARY OF THE INVENTION

The present inventors have noted that because the GCM mode forms its authentication TAG over a concatenation of the ciphertext and any non-encrypted additional data (but not the plaintext), it is possible for a dishonest user of secure data storage apparatus employing the GCM mode, to deny responsibility for having lost the secret key used to form the ciphertext (such loss preventing the recovery of the plaintext from the stored ciphertext which, of course, can have serious implications). The possibility of denial arises because the dishonest user, upon discovering they have lost the secret key, can proceed by generating a new, fake, key which the user then employs to create a new TAG from the stored ciphertext and additional data. The new TAG is then written over the original TAG formed with the original key before it was lost. The result is a stored TAG that is consistent with the stored ciphertext—however, decryption of the ciphertext using the fake key produces rubbish. The user then dishonestly complains to the manufacturer of the storage apparatus that the fault must lie with the apparatus and the manufacturer is unable to demonstrate that the stored TAG must have been later substituted by the user.

According to one aspect of the present invention, there is provided an authenticated encryption method comprising operations of:
receiving first data;
encrypting the first data, using a secret key, to form encrypted data;
forming second data by effecting a deterministic combination of the encrypted data with data characteristic of the first data; and
forming a message authentication code, MAC, in dependence on the second data.

Since the MAC is dependent on the first (plaintext) data, it is no longer possible to construct a valid MAC without knowledge of the first data thereby preventing a dishonest user who has lost the secret key from practicing the type of deception described above.

According to one aspect of the present invention, there is provided authenticated encryption apparatus comprising:
an input interface arranged to receive first data;
an encryption arrangement arranged to use a secret key to encrypt the first data to form encrypted data;
a MAC-generation arrangement arranged to receive as inputs the first data in its form prior to encryption and said encrypted data, the MAC-generation arrangement being further arranged to form second data in dependence on the first data and the encrypted data and then to form a message authentication code, MAC, in dependence on the second data; and
   an output interface arranged to output the encrypted data and the MAC.

### BRIEF DESCRIPTION OF THE DRAWINGS

Embodiments of the invention will now be described, by way of non-limiting example, with reference to the accompanying diagrammatic drawings of the prior art and of embodiments of the invention, in which:

FIG. 1 is a functional block diagram illustrating the prior art GCM mode of operation of a block cipher;

FIG. 2 is a functional block diagram of a first adaptation of the known GCM mode of block cipher operation depicted in FIG. 1;

FIG. 3 is a functional block diagram of a first embodiment of the invention in the form of a second adaptation of the known GCM mode of block cipher operation depicted in FIG. 1; and

FIG. 4 is a functional block diagram of a second embodiment of the invention in the form of a third adaptation of the known GCM mode of block cipher operation depicted in FIG. 1.

### BEST MODE OF CARRYING OUT THE INVENTION

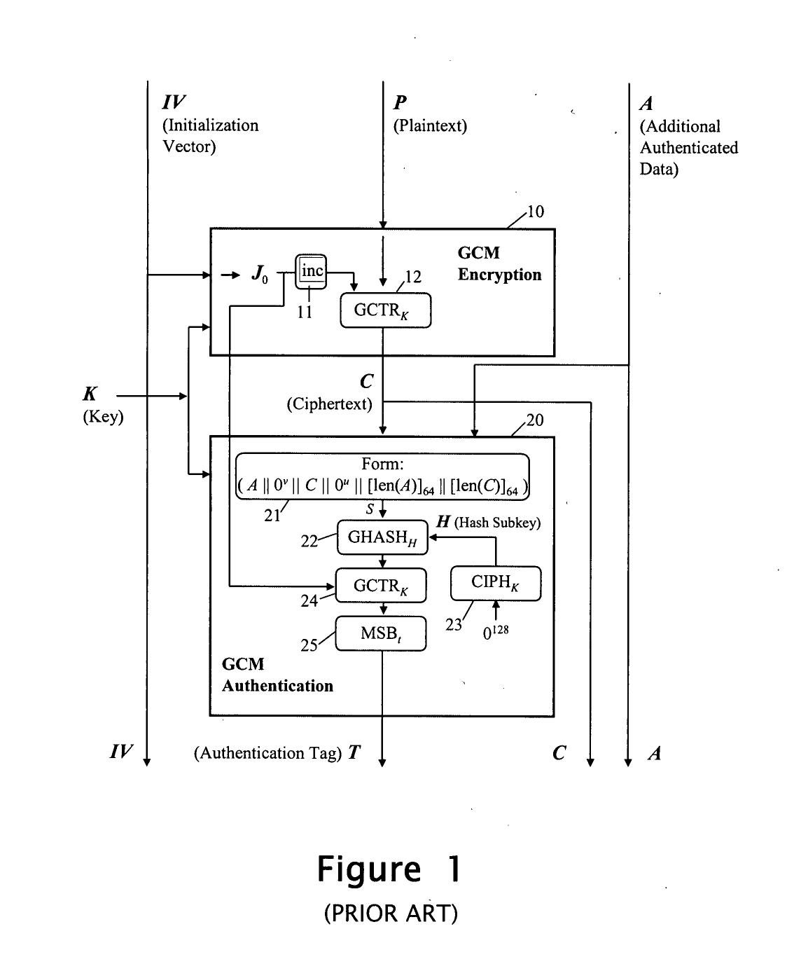

The two embodiments of the invention to be described below are both adaptations of the known GCM mode of operation of a block cipher. Accordingly, a brief description will first be given, with reference to FIG. 1, of the functional blocks making up the GCM mode of block cipher operation as specified in the above NIST Recommendation. The details of the various mathematical components implemented by the GCM functional blocks are not repeated here as they are well known to persons skilled in the art and are set out in the NIST Recommendation. These components comprise:
inc an incrementing function used in the Counter mode encryption within GCM to generates a sequence of blocks from an initial block;
GHASH_{H} is a hash function for application across a group of data blocks, the hash being dependent on a further block H referred to as the ‘hash subkey’;
CIPH_{K} a block cipher (such as AES—Advanced Encryption Standard) using secret key K;
GCTR_{K} is an encryption function for application to a sequence of data blocks, the encryption function being based on the block cipher CIPH_{K} and taking an input initial counter block ICB;
MSBₜ is a function providing the t leftmost bits of an input string; and
len is as function returning the bit length of its argument.

### The block size used in the GCM mode is 128 bits.

Referring to FIG. 1, the illustrated GCM functionality is arranged to receive inputs comprising:
the plaintext P to be encrypted,
additional data A which, although not to be encrypted, is to be authenticated,
an initialization vector IV, and
the secret key K;
   and to provide outputs comprising:
ciphertext C formed from the plaintext data P, and
authentication tag T, of length t, formed over data comprising the ciphertext C and the additional data A.

The GCM functionality of FIG. 1 comprises a GCM encryption functional block 10 and a GCM authentication functional block 20.

The GCM encryption functional block 10 is provided with the plaintext P, the initialization vector IV and the key K. A block J₀ is formed from the initialization vector IV. The inc function is applied to J₀ (see box 11) and the resultant block is passed to the encryption function GCTR_{K} (see box 12) which uses this block and successive increments of it, in effecting counter mode encryption of the blocks of the input plaintext P under the secret key K; the output of the encryption function GCTR_{K} and of the encryption functional block 10 is the ciphertext C.

The ciphertext C, the additional data A, the block J₀, and the key K are passed to the GCM authentication functional block 20.

In the GCM authentication functional block 20, the additional data A and the ciphertext C are first each appended with the minimum number of ‘0’ bits (represented in FIG. 1 as ‘0^{v} and 0″ respectively) so that the bit lengths of the resulting strings are multiples of the block size. The concatenation of these strings is appended with 64-bit representations of the lengths of the additional data A and the ciphertext C (see box 21) to produce a string S:

S=(A ∥ 0^{v} ∥ C ∥ 0″ ∥ [len(A)]₆₄ ∥ [len(C)]₆₄)

where ∥ represents string concatenation.

The GHASH_{H} function is applied to the string S to produce a single output block (see box 22), the hash subkey H being produced by applying the block cipher CIPH_{K} to a block of zeroes 0¹²⁸ (see box 23). The output of box 22 is then encrypted using the GCTR_{K} function with J₀ as the initial counter block (see box 24); the result is truncated to the specified authentication tag length t using the function MSBₜ to form the authentication tag T (see box 25). The ciphertext C and the tag T are then output from the GCM encryption block 20.

It will be apparent from the foregoing that the value of the authentication tag T is dependent on the ciphertext C and the additional data A; however, the tag T is not dependent on the plaintext string P (except, of course, indirectly through the ciphertext string C).

The ciphertext C, additional data A, authentication tag T and initialization vector IV are made available to an intended recipient by transmission or storage. The complementary authenticated decryption process is straightforward and will not be described in detail; simply put, the ciphertext C is decrypted by applying the function GCTR_{K} to the ciphertext and the validity of the supplied ciphertext C and additional data A is verified by recalculating the value of the authentication tag T and comparing the recalculated value with the supplied value—only if the tag values match are the values of the supplied additional data and ciphertext (and thus the recovered plaintext) taken as valid. Because the authentication tag value is not dependent on the plaintext, the verification process can be effected in advance of decrypting the ciphertext.

As already discussed, the fact that the authentication tag is not directly dependent on the plaintext makes it possible for the original tag to be replaced by an apparently-valid tag generated using a fake key.

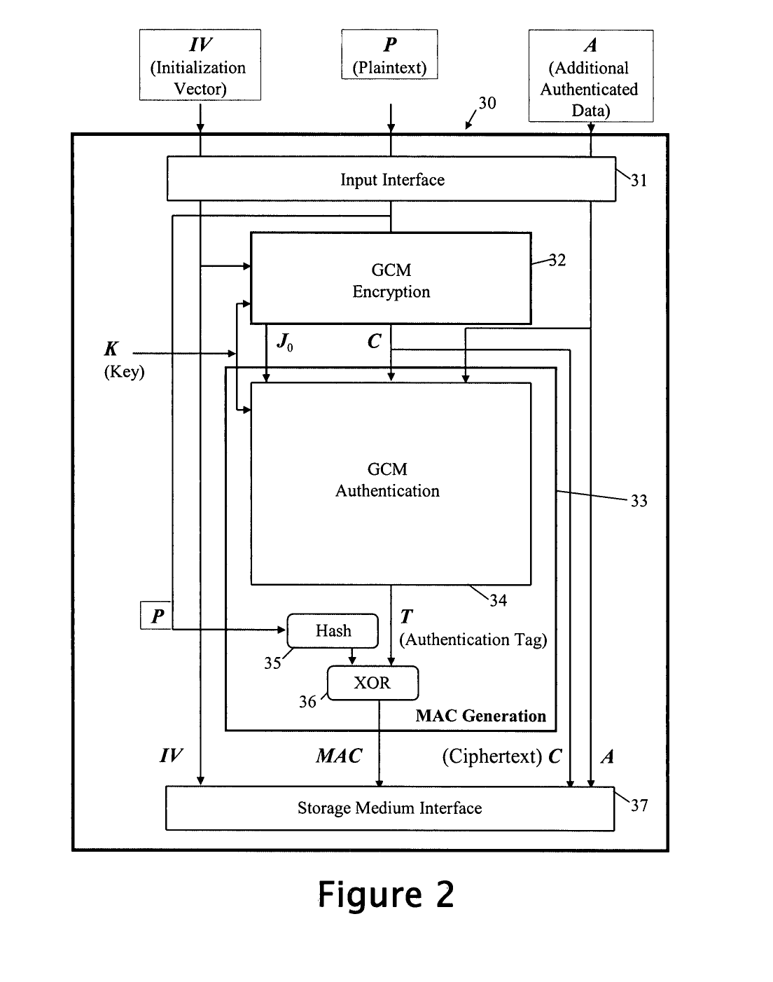

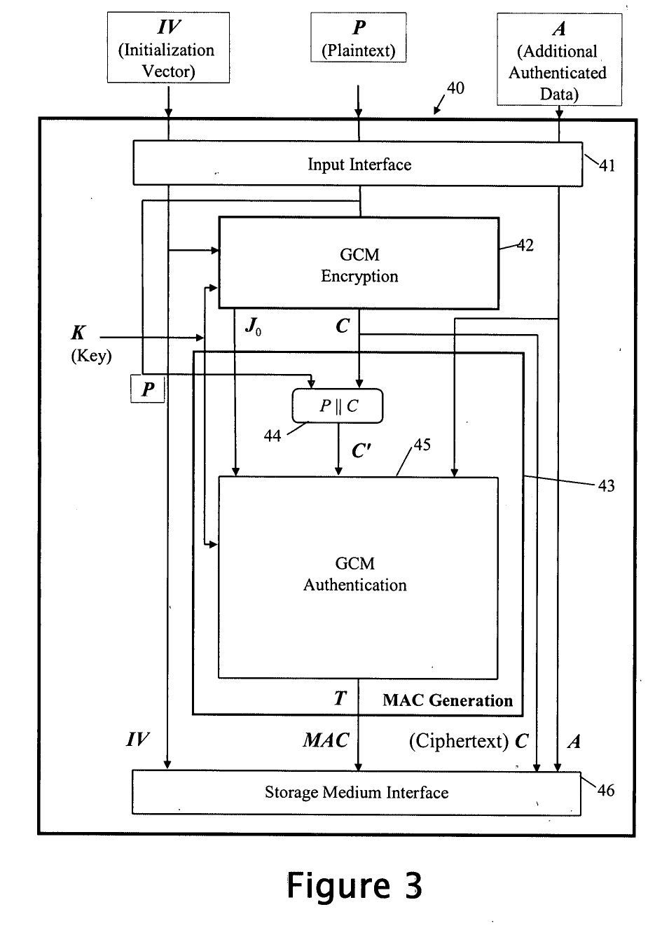

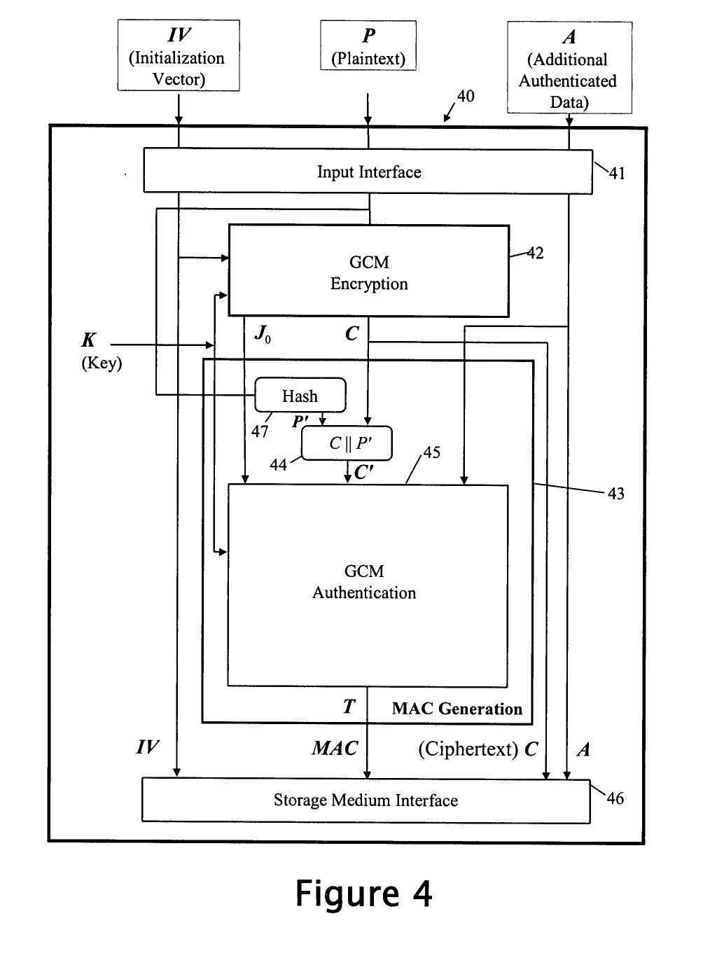

To overcome this potential drawback, it is proposed to cause the authentication tag to have a direct dependency on the plaintext data P. Thus the arrangement illustrated in FIG. 2 provides an adaptation of the GCM mode in which the authentication tag produced by the GCM authentication block is combined with a digest of the plaintext data P to produce a message authentication code MAC that is output in place of the tag T; as will be described more fully below, the FIG. 2 arrangement has certain disadvantages. The arrangements of FIGS. 3 and 4, which are respectively first and second embodiments of the present invention, are also adaptations of the GCM mode; in these embodiments the GCM authentication block is supplied, with an input that is a combination of the ciphertext C and data characteristic of the plaintext P and the output of the GCM authentication block is a message authentication code MAC that takes the place of the usual authentication tag T. For both embodiments, the output message authentication code MAC is dependent not only of the ciphertext C and any additional data A, but also on the plaintext data P, this having been achieved with minimal adaptation of the GCM mode of operation and without the disadvantages of the FIG. 2 arrangement.

The adapted GCM-mode arrangements of FIGS. 2 to 4 will now be described in more detail, all three arrangements taking the form of secure data storage apparatus arranged to store the GCM outputs to a storage medium such as a magnetic tape; it will be appreciated that the GCM mode adaptations incorporated in the arrangements of FIGS. 2 to 4 could equally be applied to other types of apparatus using authenticated encryption, such as secure data-transmission apparatus.

Considering first the secure data storage apparatus 30 of FIG. 2, the apparatus 30 comprises:
an input interface 31 arranged to receive as inputs: plaintext data P, additional data A, and an initialization vector IV (the initialization vector may alternatively be generated internally by the apparatus);
a GCM encryption arrangement 32 providing the functionality of the GCM encryption block 10 of FIG. 1 and arranged to generate ciphertext C from the input plaintext P;
a MAC generation arrangement 33 for generating a message authentication code MAC and including a GCM authentication arrangement 34 providing the functionality of the GCM authentication block 20 of FIG. 1; and
an output interface in the form of a storage medium interface 37 for writing the ciphertext C, the message authentication code MAC, the additional data A, and the initialization vector IV to a storage medium.

In addition to the GCM authentication arrangement 34, the MAC generation arrangement 33 comprises:
a hash functional block 35 for generating a digest of the plaintext P using, for example, a secure hash function, and
a combining functional block 36 for generating the message authentication code MAC by effecting a deterministic combination of the digest produced by block 33 and the authentication tag T output by the GCM authentication arrangement 34—in FIG. 2, the deterministic combination effected by the block 36 is an Exclusive ORing (XOR) of the digest and tag T.

As already indicated, the effect of the FIG. 2 arrangement is to adapt the GCM mode by replacing the authentication tag T normally output by the GCM mode with a message authentication code MAC that is a combination of the tag T and a digest of the plaintext P; the output authentication code is thus directly dependent on the input plaintext P.

In order to avoid needing to hold a long plaintext P in memory, the digest is preferably formed block by block of the plaintext.

Authenticated decryption is effected in respect of the stored outputs of the FIG. 2 arrangement in substantially the same way as for GCM authenticated decryption except that recalculation of the authentication code is effected in accordance with MAC generation in FIG. 2.

The FIG. 2 apparatus provides the desired dependency of the MAC on the input plaintext P, thereby preventing a dishonest user who has lost the secret key from practicing the type of deception described above since knowledge of the plaintext P ( or at least its hash) is needed to construct a valid MAC. However, the protection provided against the aforesaid type of deception is relatively weak since all that a dishonest user need do to circumvent it is to store a copy of the tag T along with the other stored data (the ciphertext C, the message authentication code MAC, the additional data A, and the initialization vector IV)—it will be appreciated that volume of this extra stored data is very small. Given the values of the MAC and tag T, a dishonest user can easily recover the hash of the plaintext P and use this hash to recompute a MAC that is consistent with the stored ciphertext for a fake encryption key.

Considering next the secure data storage apparatus 40 of FIG. 3, the apparatus 40 comprises:
an input interface 41 arranged to receive as inputs: plaintext data P, additional data A, and an initialization vector IV (the initialization vector may alternatively be generated internally by the apparatus);
a GCM encryption arrangement 42 providing the functionality of the GCM encryption block 10 of FIG. 1 and arranged to generate ciphertext C from the input plaintext P;
a MAC generation arrangement 43 for generating a message authentication code MAC and including a GCM authentication arrangement 45 providing the functionality of the GCM authentication block 20 of FIG. 1; and
an output interface in the form of a storage medium interface 46 for writing the ciphertext C, the message authentication code MAC, the additional data A, and the initialization vector IV to a storage medium.

In addition to the GCM authentication arrangement 45, the MAC generation arrangement 43 comprises a combining functional block 44 for effecting a deterministic combination of the ciphertext C and the plaintext P to produce an output C′ that is then passed to the GCM authentication arrangement 45 instead of the ciphertext C. In FIG. 3, the deterministic combination effected by the block 44 is depicted, by way of example, as a concatenation of the ciphertext C and the plaintext P (it should be noted that this results in an increase in the number of blocks requiring to be processed by the GHASH_{H} function of the GCM authentication arrangement 45). The deterministic combination effected by block 36 should not be an Exclusive OR (XOR) combination since C is actually formed as:

C=(P)XOR(the encrypted counter)

so that (C)XOR(P) would simply produce the encrypted counter.

As already indicated, the effect of the FIG. 3 embodiment is to adapt the GCM mode by replacing the authentication tag T normally output by the GCM mode with a message authentication code MAC that corresponds to a tag generated over a concatenation of the additional data and a combination of the plaintext P and ciphertext C; the output authentication code is thus directly dependent on the input plaintext P.

Authenticated decryption is effected in respect of the stored outputs of the FIG. 3 embodiment in substantially the same way as for GCM authenticated decryption except that recalculation of the authentication code is effected in accordance with MAC generation in FIG. 3.

The second embodiment, shown in FIG. 4, is similar to that of FIG. 3 except that the plaintext P is hashed in block 47 to produce a digest P′ that is then combined in block 44 with the ciphertext C. The embodiments of FIGS. 3 and 4 thus both combine data characteristic of the plaintext P with the ciphertext C and pass the resultant combination to the GCM authentication block 45.

In the FIG. 4 embodiment, unlike that of FIG. 3, the deterministic combination effected by block 44 can be an Exclusive OR combination between the plaintext digest P′ and the ciphertext C (more particularly, between the digest P′ and a predetermined block of the ciphertext C since typically the digest will be one block length whereas the ciphertext will be multiple blocks in length).

It will be appreciated that the functional blocks described above with reference to the accompanying drawings can be implemented either in dedicated hardware circuitry and/or by one or more program-controlled general purpose processors. It will be further appreciated that many variants are possible to the above described embodiments of the invention; for example, variations can be made to the GCM authentication block such as by combining the additional data A and ciphertext C by a deterministic combining function other than concatenation. Indeed, the invention is not limited to adaptations of the GCM mode or to the use of the AES block cipher.

1. An authenticated encryption method comprising operations of:
receiving first data;
encrypting the first data, using a secret key, to form encrypted data;
forming second data by effecting a deterministic combination of the encrypted data with data characteristic of the first data; and
forming a message authentication code, MAC, in dependence on the second data.

2. A method according to claim 1, further comprising receiving additional data, the MAC being formed in dependence on the additional data as well as in dependence on the second data.

3. A method according to claim 1, comprising the further step of storing the encrypted data and the MAC to a storage medium.

4. A method according to claim 1, wherein the second data is forming by effecting a deterministic combination, other than an Exclusive OR function, of the encrypted data with the first data.

5. A method according to claim 1, wherein the second data is forming by effecting a deterministic combination of the encrypted data with a hash of the first data.

6. A method according to claim 1, wherein the first data is encrypted using a block cipher operating in the Counter Mode, the MAC being formed by applying Galois/Counter Mode authentication to data comprising the second data.

7. A method according to claim 6, further comprising receiving additional data, the MAC being formed by applying Galois/Counter Mode authentication to data comprising both the second data and the additional data.

8. A method according to claim 6, comprising the further step of storing the encrypted data and the MAC to a storage medium.

9. A method according to claim 7, comprising the further step of storing the encrypted data, the MAC and the additional data to a storage medium.

10. A method according to claim 6, wherein the second data is forming by effecting a deterministic combination, other than an Exclusive OR function, of the encrypted data with the first data.

11. A method according to claim 6, wherein the second data is forming by effecting a deterministic combination of the encrypted data with a hash of the first data.

12. Authenticated encryption apparatus comprising:
an input interface arranged to receive first data;
an encryption arrangement arranged to use a secret key to encrypt the first data to form encrypted data;
a MAC-generation arrangement arranged to receive as inputs the first data in its form prior to encryption and said encrypted data, the MAC-generation arrangement being further arranged to form second data in dependence on the first data and the encrypted data and then to form a message authentication code, MAC, in dependence on the second data; and
an output interface arranged to output the encrypted data and the MAC.

13. Apparatus according to claim 12, wherein the input interface is further arranged to receive additional data, the MAC-generation arrangement being further arranged to receive the additional data as a said input and to form the second data in dependence on the additional data as well as in dependence on the first data in its form prior to encryption, and said encrypted data.

14. Apparatus according to claim 12, wherein the output interface is a storage medium interface arranged to write the encrypted data and the MAC to a storage medium.

15. Apparatus according to claim 12, wherein the MAC-generation arrangement is arranged to form the second data by effecting a deterministic combination, other than an Exclusive OR, of the encrypted data with the first data.

16. Apparatus according to claim 12, wherein the MAC-generation arrangement is arranged to form the second data by effecting a deterministic combination of the encrypted data with a hash of the first data.

17. Apparatus according to claim 12, wherein the encryption arrangement is arranged to encrypt the first data using a block cipher operating in the Counter Mode, and the MAC-generation arrangement is arranged to form said MAC by applying Galois/Counter Mode authentication to data comprising the second data.

18. Apparatus according to claim 17, wherein the input interface is further arranged to receive additional data; the MAC-generation arrangement being arranged to form said MAC by applying Galois/Counter Mode authentication to data comprising both the second data and the additional data.

19. Apparatus according to claim 17, wherein the output interface is a storage medium interface arranged to write the encrypted data and the MAC to a storage medium.

20. Apparatus according to claim 18, wherein the output interface is a storage medium interface arranged to write the encrypted data, the MAC and the additional data to a storage medium.

21. Apparatus according to claim 17, wherein the MAC-generation arrangement is arranged to form the second data by effecting a deterministic combination, other than an Exclusive OR, of the encrypted data with the first data.

22. Apparatus according to claim 17, wherein the MAC-generation arrangement is arranged to form the second data by effecting a deterministic combination of the encrypted data with a hash of the first data.
